(19) United States
(12) Patent Application Publication
(10) Pub. No.: US 2021/0163368 A1
(43) Pub. Date: Jun. 3, 2021

(54) METHOD FOR PRODUCING A CERAMIC COMPONENT

(71) Applicant: SGL CARBON SE, Wiesbaden (DE)

(72) Inventors: Oswin ÖTTINGER, Meitingen (DE); Tanja DAMJANOVIC, Meitingen (DE); Niklas KRABLER, Meitingen (DE); Arash RASHIDI, Meitingen (DE); Sebastian SARTOR, Meitingen (DE); Sebastian SCHULZE, Meitingen (DE)

(73) Assignee: SGL CARBON SE, Wiesbaden (DE)

(21) Appl. No.: 17/059,310

(22) PCT Filed: May 27, 2019
(86) PCT No.: PCT/EP2019/063638

§ 371 Date: Nov. 27, 2020

(30) Foreign Application Priority Data
May 28, 2018 (DE) 10 2018 208 427.0

(51) Int. Cl. C04B 41/48; C04B 41/45; C04B 35/565

(52) U.S. Cl. CPC C04B 41/4853; C04B 41/4515; C04B 35/565; C04B 2235/9607; C04B 2235/5436; C04B 2235/616; C04B 2235/6026

(57) ABSTRACT

A method for producing a ceramic component from a composite material containing at least one hard material and plastic, to the component produced by said method and to the use of said component. Hie method includes the following steps: a) providing a green body comprising at least one hard material, which has been produced by means of a 3D printing method, b) impregnating the green body with at least one liquid resin system and c) curing the impregnated green body to form a synthetic resin matrix. The hard material is preferably SiC and/or B4C.

The present invention relates to a method for producing a ceramic component from a composite material containing at least one hard material and plastic, to the component produced by this method and to the use of this component.

Ceramic components are generally characterised by high hardness, high wear resistance, high chemical stability and high strength even at high temperatures. Due to these properties, ceramic components are used anywhere where they, for example, are exposed to high mechanical and/or chemical loads, aggressive or corrosive media, for example in pumps, pipelines or nozzles.

DE 10327494 E1 describes composite pump components comprising a metal part and a hybrid casting, which is a cured mixture of a plastic acting as a binder and a fine-grained, wear- and corrosion-resistant material. Epoxy resin, vinyl ester resin or polymethacrylate arc listed as the plastic, and silicon carbide (SiC), corundum, quartz sand, glass or a mixture of these materials are listed as the wear- and corrosion-resistant material. In the production of these composite parts, the metal part is used as a casting mould for the hybrid casting. The disadvantage of the production of these pump components is that casting moulds are required, which are normally only available in limited numbers. Therefore, this process is expensive and lengthy due to the required use of casting moulds. Furthermore, the shape of the hybrid casting is determined by the shape of the casting mould.

The object of the present invention is therefore to provide a method for producing a ceramic component which does not require a casting mould, which has a shorter, and thus less costly. process time, and which allows the ceramic components to be produced in any shape in a simple manner.

In the context of the present invention, this object is achieved by providing a method for producing a ceramic component from a composite material containing at least one hard material and plastic, comprising the following steps:

a) providing a green body comprising at least one hard material produced by a 3D printing process,

b) impregnating the green body with at least one liquid resin system and

c) curing the impregnated green body to form a synthetic resin matrix.

According to the invention, it has been found that, when the green body comprising at least one hard material is produced by means of 3D printing, the process time to produce the ceramic component is significantly reduced, also resulting in a leas costly process. In addition, it is possible to produce a larger number of ceramic components in a shorter time because no casting moulds are required.

In the context of the present invention, a hard material is understood to be a material which has a Mohs hardness of greater than/equal to (≥) 8.5, preferably of 9.0, particularly preferably of ≥9.3. The Mohs hardness represents a relative hardness value on a scale of 1 to 10. A material that has a Mohs hardness of 1 to 2 represents a soft material; a medium-hard material has a Mohs hardness of 3 to 5, and a hard material has a Mohs hardness of 6 to 10. Mohs hardness is determined by ascertaining whether a material A can scratch a material B, but material B cannot scratch material A. Consequently, harder materials scratch softer materials.

Preferred hard materials for the method according to the invention are silicon carbide (SiC), boron carbide (B₄C) or any mixture of SiC and B₄C, preferably SiC. If SiC or B₄C is used as the sole hard material, these materials are used as pure hard materials, i.e. there is no mixing with other materials. By using B₄C instead of SiC in the production of the green body, the hardness of the ceramic component produced with it is increased and the weight of this component is reduced. If any mixture of SiC and B₄C is used, the ratio of SiC to B₄C used depends on the properties of the ceramic component.

The green body in step a) is produced by means of a 3D printing process. This process provides a hard material powder with a grain size (d50) between 13 μm and 500 μm, preferably between 60 μm and 350 μm, more preferably between 70 μm and 300 μm, particularly preferably between 75 μm and 200 μm, and a liquid binder. This is followed by deposition of a layer of the powder over a surface, followed by local deposition of droplets of the liquid binder onto this layer. These steps are repeated until the desired shape of the component is produced, with each individual step being adapted to the desired shape of the component. Afterwards, the binder is at least partially cured or dried, resulting in the green body having the desired shape of the component. The term “d50” means that 50% of the particles are smaller than the specified value. The d50 value was determined with the aid of the laser granulometry method (ISO 13320), using a measuring device from Sympatec GmbH with associated evaluation software.

In order to produce a green body comprising more than one hard material, a mixture of the hard materials SiC and B₄C is used for the surface deposition step. The individual hard material powders have the grain size described above.

Obtaining a green body with the desired shape of the component has the following meaning. Immediately after the binder has cured or dried, the green body is still surrounded by a powder coating of loose particles of the powdery composition. The green body must therefore be removed from the powder coating or separated from the loose, non-compacted particles. This is also known in the 3D printing literature as “unpacking” the printed part. The unpacking of the green body may be followed by (fine) cleaning of the green body to remove adherent particle residues. Unpacking can be achieved, for example, by vacuuming off the loose particles with a powerful suction device. However, the type of unpacking is not particularly limited, and all known methods can be used.

During the production of the green body, it can be advantageous to add a liquid activator, such as a liquid sulphuric acid activator, to the at least one hard material. By using such an activator, on the one hand the curing time and the temperature required for curing the binder can be reduced, and on the other hand the dust formation of the powdery composition is reduced. Advantageously, the amount of activator is 0.05% by weight to 0.2% by weight, based on the total weight of the at least one hard material and activator. If more than 0.2% by weight based on the total weight of activator and the at least one hard material is used, the powdery composition will stick together and the flowability will be reduced; if less than 0.05% by weight based on the total weight of the at least one hard material and activator is used, the amount of activator which can react with the binder, more precisely the resin component of the binder, will be too small to achieve the desired above-mentioned advantages.

The selection of the binder used to produce the 3D-printed green body is not particularly limited. Suitable binders are, for example, phenolic resins, furan resins, water glass or any mixture of these. Solutions of the mentioned binders are also included here. The advantage of these binders is that they only need to be hardened or dried, which makes the production process more cost-effective. Furan resins and phenolic resins are preferred because the corresponding green bodies have a particularly high stability and these binders exclusively form carbon in the event of a possible carbonisation.

Preferably, the proportion of the binder in the green body is 1.0 to 10.0 % by weight, and most preferably 1.5 to 6.0% by weight, based on the total weight of the green body.

Within the scope of the invention, the green body is impregnated with at least, one liquid resin system according to step b). Here, a liquid resin system comprises at least one resin, at least one solvent and at least one hardener, wherein the at least one resin and the at least one solvent can be identical.

The preferred liquid resin system is a resin system that is converted into a synthetic resin matrix by means of a polycondensation reaction or a polyaddition reaction. A polycondensation reaction is a condensation reaction which is carried out in stages via stable but still reactive intermediate products and in which macromolecules such as polymers or copolymers are formed from many low-molecular substances (monomers) by splitting off simply constructed molecules, usually water. These macromolecules are also called polycondensates. For a monomer to participate in the reaction, it must have at least two functional groups that are particularly reactive, for example an —OH group. This process takes place several times in succession until a macromolecule has formed. A polyaddition reaction is understood to be a reaction that represents a form of polymer formation that takes place according to the mechanism of nucleophilic addition of monomers to polyadducts. In this process, molecules of different types are linked to at least two functional groups by transferring protons, i.e. from one group to another. A prerequisite for this is that the functional groups of a molecule type contain double bonds. Similarly to polycondensation, polyaddition proceeds in stages, but no low-molecular by-products, such as water, are formed. The use of liquid resin systems which are converted into a synthetic resin matrix by means of a polyaddition reaction leads to comparatively dense ceramic components with high strength, whereas the use of liquid resin systems which are converted into a synthetic resin matrix by means of a polycondensation reaction leads to ceramic components which have a high chemical stability and a particularly high temperature stability.

Preferably, the at least one liquid resin system which is converted to a synthetic resin matrix by means of a polyaddition reaction represents an epoxy resin, a polyurethane resin or a benzoxazine resin, and the at least one liquid resin system which is converted into a synthetic resin matrix by means of a polycondensation reaction represents a phenolic resin or a furan resin. Epoxy resins or polyurethane resins are characterised by their particularly high mechanical stability, i.e. a high bending strength, and phenolic resins or furan resins are characterised by their particularly high chemical stability, even at particularly high temperatures, and high temperature stability. Benzoxazine resins are characterised by the fact that they have both advantageous properties of resins that have been converted into a resin matrix by means of a polyaddition reaction or a polycondensation reaction. When curing to form a synthetic resin matrix, benzoxazine resins do not split off by-products such as water, and this matrix has a high temperature stability. This at least one liquid resin system can also be any mixture of a resin system that has beer, converted into a synthetic resin matrix by a polyaddition reaction and a resin system that has been converted into a synthetic resin matrix by a polycondensation reaction. For example, it is thus possible to use a mixture of an epoxy resin with a furan resin or a phenolic resin, or a mixture of a polyurethane resin with a furan resin or a phenolic resin, or a mixture of a benzoxazine resin with a furan resin or phenolic resin.

The impregnation with at least one liquid resin system according to step b) can be carried out by spraying, dipping, brushing, vacuum impregnation or by vacuum pressure impregnation. For vacuum impregnation, the vacuum used depends on the boiling point(s) of the solvent(s) of the at least one liquid resin system. In the case of vacuum pressure impregnation, the pressure used depends on the equipment, used for vacuum pressure impregnation. Depending on the system, it is possible to use a pressure of typically up to 16 bar.

Curing according to step c) of the method according to the invention is understood to mean complete curing. This curing is preferably carried out at room temperature or by applying a temperature in a range of 60° C. to 250° C., more preferably in a range of 120° C. to 200° C.

According to another preferred embodiment of the present invention, the steps of impregnation with at least one liquid resin system which is converted into a synthetic resin matrix by means of polycondensation according to step b) and curing according to step c) are repeated at least once. By this repetition of steps b) and c) of the method according to the invention, the bending strength of the ceramic component is increased. During polycondensation, the split-off molecules, usually water, escape, thus creating pores in the component. After curing, these pores are filled during the next impregnation with the aforementioned at least one liquid resin system.

According to another preferred embodiment of the present invention, in step b) an impregnation with at least one liquid resin system which is converted into a synthetic resin matrix by means of a polycondensation reaction is carried out, and, after step c) of curing, a step d) of carbonising the cured component is carried out, followed by the steps of e) impregnating the carbonised body with a liquid resin system which is converted into a synthetic resin matrix by means of a polyaddition reaction or a polycondensation reaction and f) curing the impregnated body to form, a synthetic resin matrix. This embodiment is preferably used when SiC is used as the hard material.

The term “carbonisation” according to step d) above is understood to mean the thermal conversion of the resin system contained by the green body into carbon. Carbonisation can be carried out by heating to temperatures in the range of 500° C.-1100° C., preferably from 800° C. to 1000° C., in an inert gas atmosphere (e.g. argon or nitrogen atmosphere) with subsequent holding time.

The resin of the liquid resin system according to step b), which is converted into a synthetic resin matrix by means of a polycondensation reaction, is converted into carbon during the carbonisation process, as a result of which conductive binder bridges are formed between the hard-material grains. This significantly increases the electrical conductivity of the corresponding ceramic component, especially when using SiC as the hard material. As an alternative to polycondensation resins, benzoxazine resins can also be used, since this class of resins also shows a carbon yield during the carbonisation step in the same way as typical polycondensation resins, e.g. phenolic resins or furan resins. By using a liquid resin system when impregnating the carbonised body according to step e), which system is converted into a synthetic resin matrix by means of a polyaddition reaction, an increase in the impermeability and strength of the ceramic component is achieved.

The present invention also relates to a ceramic component made of a composite material containing at least one hard material and plastic, which component can be produced according to the above method according to the invention.

Preferably, the component according to the invention has a specific electrical resistance of less than 10,000 μOhm*m, preferably loss than 7,000 μOhm*m. The component according to the invention also preferably has a Shore hardness D of greater than/equal to 90. The Shore hardness represents a characteristic value for plastics. When determining the Shore hardness, a spring-loaded pin made of hardened steel is used, and the penetration depth of this pin into the material to be tested is a measure of the Shore hardness. The Shore hardness is measured on a scale from 0 Shore (2.5 millimetres penetration depth) to 100 Shore (0 millimetre penetration depth). A high number therefore means a great hardness.

In addition, the component according to the invention preferably has a thermal conductivity of at least 2.0 W/(m*K), more preferably of at least 3.0 W/(m*K).

The strength of the components according to the invention depends on the at least one liquid resin system with which the green body is impregnated. A strength of at least 60 MPa is achieved if impregnation with at least one liquid resin system which reacts by means of a polyaddition reaction is carried out; on the other hand, if impregnation with at least one liquid resin system which reacts by means of a polycondensation reaction is carried out, the corresponding component has a strength of at least 40 MPa.

The components according to the invention are characterised by a comparatively high electrical and thermal conductivity. In addition, these components have a low thermal expansion, i.e. they are dimensionally stable for a certain time oven at high temperatures of over 1,000° C. This is especially true for components according to the invention which contain SiC as the hard material. This stability at high temperatures can also be achieved if SiC is used as the hard material and if a resin system which is converted into a synthetic resin matrix by means of a polycondensation reaction, such as furan or phenolic resin, is used as at least one liquid resin system. When temperatures above 1,000° C. are applied, in-situ carbonisation occurs. However, it is also possible that a carbonisation step is applied after the above-mentioned impregnation step. This carbonisation step can be followed by a further impregnation step with the same liquid resin system; here again, in-situ carbonisation takes place. These embodiments are particularly important when used as a material in the field of high-temperature moulding tools.

Due to the aforementioned advantageous properties, the component according to the invention can be used in various applications. At temperatures of up to 220° C., the components according to the invention are suitable, depending on the liquid resin system used, as an impeller and shut-off or rotary valve in pumps and compressors, as a pump casing, as a classifier wheel, as internals in columns, as static mixing elements, as turbulators, as spray nozzles, and as a lining element for protecting against wear and in corrosive applications. If this component according to the invention is to have a high impermeability and high strength, for example when used as an impeller and shut-off or rotary valve in pumps and compressors or as a pump casing, an epoxy resin can be used as the liquid resin system. In cases where the components according to the invention are to have high chemical and temperature stability, for example when used as internals in columns, as static mixing elements or in corrosive applications, a phenolic resin or a furan resin can be used. At temperatures of more than 220° C., the component according to the invention can be used as an electrical heating element or as an oxidation-stable high-temperature mould for casting, sintering or pressing. For example, such high-temperature moulds can be used for the production of drill inserts. These high-temperature moulds are preferably produced by the method variant, with intermediate impregnation with at least one liquid resin system which is converted into a synthetic resin matrix by means of a polycondensation reaction, and with a carbonisation step.

In the following, the present invention is described by means of examples which are explanatory, but not limiting.

### EXAMPLES

The production of a green body using silicon carbide as hard material according to step a) of our method according to the Invention can be carried out as described below.

A silicon carbide with grain size F80 (grain size according to FEPA standard) was used. This was first mixed with 0.1 % by weight of a sulphuric acid liquid activator for phenolic resin. based on the total weight of silicon carbide and activator, and processed with a 3D printing powder bed machine. A doctor blade unit placed a thin layer of silicon carbide powder (approximately 0.3 mm high) on a flat powder bed, and an inkjet printing unit printed an alcoholic phenolic resin solution onto the silicon carbide powder bed according to the desired component geometry. The printing table was then lowered by the thickness of the layers, and another layer of silicon carbide was applied and phenolic resin was again printed on locally. By repeating this procedure, cuboidal test specimens with dimensions of, for example, 120 mm (length)×20 mm (width)×20 mm (height) were constructed. Once the complete “component” was printed, the powder bed was placed in an oven preheated to 160° C. and held there for approximately 20 hours, during which time the phenolic resin completely cured and formed a dimensionally stable green body. The excess silicon carbide powder was then vacuumed off after cooling, and the green body was removed. The geometric density of the test specimen was determined to be 1.45 g/cm³.

### Example 1 According to the Invention

The silicon carbide-based green body, produced by a 3D printing process, was vacuum impregnated with a liquid epoxy resin system The epoxy resin from Ebalta consisted of 100 parts of a resin with a room temperature (RT) viscosity of approximately 800 mPas and 30 parts of the corresponding fast-curing hardener with an RT viscosity of approximately 55 mPas. The pot life of the epoxy resin system is stated as 50-60 minutes according to the manufacturer's specifications. The test specimen was completely immersed in the liquid resin system and evacuated to approx. 100 mbar. The test specimen was impregnated in the resin system under vacuum for a further 30 minutes, and, after this time, it was brought to ambient pressure, removed from the container and cleaned superficially of the adhering resin. After storage at room temperature and subsequent curing at 60° C., the corresponding test specimen geometries for the physical tests were worked out mechanically from the rods. The density of the test specimens was 2.0 g/cm³. The test specimen surfaces were finally available in a ground quality.

### Example 2 According to the Invention

The silicon carbide-based green body, produced by a 3D printing process, was subjected to vacuum pressure impregnation instead of an epoxy resin impregnation with a phenol formaldehyde resin (Hexion) with a viscosity at 20° C. of 700 mPas and a water content according to Karl Fischer (ISO 760) of approx. 15%. The procedure was as follows: the carbon bodies were placed in an impregnation vessel. The pressure in the vessel was reduced to 10 mbar and increased to 11 bar after the resin was applied. After a dwell time of 10 hours, the carbon test specimens were removed from the impregnation vessel and heated to 160° C. under pressure of 11 bar to cure the resin. The heating time was approximately 2 hours, and the dwell time at 160° C. was approximately 10 hours. After polycondensation curing, the cooled test specimens had a density of 2.0 g/cm³.

### Example 3 According to the Invention

The silicon carbide-based green body, which was produced using a 3D printing process, was first subjected to dip impregnation with furan resin. The advantage of the furan resin impregnation is the extremely low viscosity of the furan resin system of less than 100 mPas, which means that pure impregnation can be implemented without the need for vacuum or pressure. The following procedure was used: the specimens were placed in a glass vessel and a pre-prepared solution of one part maleic anhydride (Aug. Hedinger GmbH 6 Co. KG) and 10 parts furfuryl alcohol (International Furan Chemicals B.V.) was poured thereover. The test specimens were immersed completely in the solution for the complete infiltration time of two hours (at room temperature). After infiltration of the furfuryl alcohol/maleic acid anhydride solution, the specimens were removed and cleaned superficially using a cell cloth. The specimens soaked with resin were then cured in a drying cabinet. The temperature was gradually increased from 50° C. to 150° C. The actual curing program was as follows: 19 hours at 50° C., 3 hours at 70° C., 3 hours at 100° C. and finally 1.5 hours at 150° C. The mean density of the furan resin-impregnated test specimens was determined to be 1.70-1.75 g/cm³ after curing. After curing, the impregnated SiC green body was carbonised at 900° C. in a nitrogen atmosphere. For the carbonisation treatment, a slow heating curve over 3 days at 900° C. was chosen to ensure that the green body would not burst duo to the sudden evaporation of the solvent, i.e. water. During the carbonisation treatment, the furan resin is converted into carbon and thus forms conductive binder bridges between the SiC grains. Finally, the carbonised bodies were impregnated with epoxy resin according to example 1 and further processed.

All test specimens of examples 1-3 were subjected to a material characterisation. The results of these tests are shown in the following table, where the measurement results of the pure epoxy resin are included as a comparison:

| | | | Example 2: | Example 3: |
|---|---|---|---|---|
| | | Example 1: | Phenolic | Conductive |
| | | EP- | resin- | SiC body |
| | Pure epoxy | impregnated | impregnated | with EP |
| | resin (EP) | SiC | SiC | impregnation |
| AD (g/cm³) | 1.2 | 2.0 | 2.0 | 2.1 |
| ER (Ohmμm) | >10⁷ | >10⁷ | >10⁷ | 5500 |
| YM 3p (GPa) | 3.5 | 13 | 19 | 15 |
| FS 3p (MPa) | 105 | 95 | 57 | 40 |
| CS (MPa) | 101 | 121 | 134 | 91 |
| Shore D | 85 | 91 | 92 | 93 |
| TC | 0.2 | 2.4 | 3 | 4 |
| (W/(m*K)) | | | | |

AD (g/cm³): density (geometric) according to ISO 12985-1
ER (Ohmμm): electrical resistance according to DIN 51911
YM 3p (GPa): modulus of elasticity (stiffness), determined from the 3-point bending test according to EN ISO 178
FS 3p (MPa): 3-point bending strength according to EN ISO 178
CS (MPa): compressive strength according to EN ISO 604
Shore D: Shore hardness according to DIN ISO 7619-1
TC (W/(m*K)): Thermal conductivity at room temperature according to DIN 51908

The SiC composite material with an epoxy matrix (Examples 1 and 3) shows a higher strength compared to the SiC composite material with the phenolic resin matrix, but the latter is more temperature-stable and more chemically stable. With regard to the effort required for impregnation, the SiC green bodies can be impregnated with furan resin simply by means of an immersion process (partial method step in Example 3), while phenolic resin and epoxy resin must be impregnated by means of a vacuum impregnation process or vacuum pressure impregnation process due to the usually higher viscosity. The curing mechanism of epoxy resin is a polyaddition which leads to comparatively dense composite materials. The polycondensation resins such as phenol or furan resins generally have a much less dense structure.

By intermediate impregnation with a carbon-donating resin (here: furan resin) and subsequent carbonisation treatment in Example 3, a conductive SiC network with carbon binder bridges is formed. The pores are filled by the subsequent epoxy resin impregnation, resulting in a penetration composite material with good mechanical properties and good electrical conductivity.

In comparison with the pure epoxy resin, the addition of a hard material significantly reduces the thermal expansion, which can be determined according to DIN 51909. The SiC composite material with an epoxy resin matrix according to Example 1 shows a high thermal expansion compared to an SiC composite material with a phenolic resin matrix according to Example 2. For this reason, if high dimensional stability is required and thus a low thermal expansion is needed, an SiC composite material with a phenolic resin matrix or furan resin matrix alone or with a subsequent carbonisation step and re-impregnation with a phenolic resin or furan resin is preferred.

1-15. (canceled)

16. A method for producing a ceramic component from a composite material containing at least one hard material and plastic, comprising the following steps:
a) providing a green body comprising at least one hard material produced by a 3D printing process.
b) impregnating the green body with at least one liquid resin system and
c) curing the impregnated green body to form a synthetic resin matrix.

17. The method according to claim 16, wherein the at least one hard material in step a) represents silicon carbide (SiC), boron carbide (B₄C) or any mixture of SiC and B₄C.

18. The method according to claim 16, wherein at least one hard material having a grain size (d50) between 10 μm and 500 μm is used for the production of the green body.

19. The method according to claim 16, wherein the at least one liquid resin system in step b) is a resin system which is converted into a synthetic resin matrix by means of a polycondensation reaction or a polyaddition reaction.

20. The method according to claim 19, wherein the at least one synthetic resin matrix produced by means of a polyaddition reaction represents an epoxy resin, a polyurethane resin or a benzoxazine resin, or the at least one synthetic resin matrix produced by means of a polycondensation reaction represents a phenolic resin or a furan resin, or the at least one synthetic resin matrix represents any mixture of these resins.

21. The method according to claim 16, wherein the impregnation with at least one liquid resin system in step b) is carried out by spraying, dipping, brushing, vacuum impregnation or by vacuum pressure impregnation.

22. The method according to claim 16, wherein the curing in step c) is carried out at room temperature or by applying a temperature in a range of 60° C. to 250° C.

23. The method according to claim 16, wherein the steps of impregnation with at least one liquid resin system which is converted into a synthetic resin matrix by means of polycondensation according to step b) and of curing according to step c) arc repeated at least once.

24. The method according to claim 16, wherein in step b) an impregnation with at least one liquid resin system which is converted into a synthetic resin matrix by means of a polycondensation reaction is carried out, and, after step c) of curing, a step d) of carbonising the cured component is earned out, followed by the steps of e) impregnating the carbonised body with a liquid resin system which is converted into a synthetic resin matrix by means of a polyaddition reaction or a polycondensation reaction, and f) curing the impregnated body to form a synthetic resin matrix.

25. A Ceramic component made of a composite material containing at least one hard material and plastic produced by a method for producing a ceramic component from a composite material containing at least one hard material and plastic, comprising the following steps:
a) providing a green body comprising at least one hard material produced by a 3D printing process.
b) impregnating the green body with at least one liquid resin system and
c) curing the impregnated green body to form a synthetic resin matrix.

26. The ceramic component according 10 claim 25, wherein the component has a specific resistance of less than 10,000 μOhm*m.

27. The ceramic component according to claim 25, wherein the component has a Shore hardness D of greater than/equal to 90.

28. The ceramic component according to claim 25, wherein the component has a thermal conductivity of at least 2 W/(m·K).

29. The ceramic component according to claim 25, wherein the component has a strength of at least 80 MPa when impregnated with at least one liquid resin system which reacts by means of a polyaddition reaction, or has a strength of at least 40 MPa when impregnated with at least one liquid resin system which reacts by means of polycondensation.

30. A use of a ceramic component according to claim 25 as an impeller and shut-off or rotary valve in pumps and compressors, as a pump casing, as internals in columns, as static mixing elements, as turbulators, as spray nozzles, as an electrical heating element, as a classifier wheel, as a lining element for protecting against wear and in corrosive applications or as an oxidation-stable high-temperature mould.
